(19) United States
(12) Patent Application Publication
(10) Pub. No.: US 2002/0049660 A1
(43) Pub. Date: Apr. 25, 2002

(54) Methods and apparatus for exchanging shipping information and commitments

(76) Inventors: Gabriel Dario Obrador, Lexington, MA (US); J. Terrence Hammer, Acton, MA (US); William G. Davidson, Needham, MA (US)

Correspondence Address: CHARLES G. CALL, 68 HORSE POND ROAD, WEST YARMOUTH, MA, 02673-2516, US

(21) Appl. No.: 09/781,027

(22) Filed: Feb. 9, 2001

Related U.S. Application Data
(60) Provisional application No. 60/181,451, filed on Feb. 10, 2000.

(51) Int. Cl. G06F 17/60

(52) U.S. Cl. 705/37

(57) ABSTRACT

An Internet based shipping marketplace is implemented by one or more Web database servers which permit charterers and ship owners to exchange information and make commitments relating to the transportation of goods. The marketplace stores information describing participating charterers, ship owners and service providers, some of which is gathered by registration procedures used when the participants initially use the marketplace. The marketplace implements the information distribution, matching, negotiation and documentation functions needed to form binding commitments that govern the shipment of cargoes by vessel owners on behalf of charterers. The shipping marketplace accepts and stores information from individual ship owners that identifies individual vessels and describes their current location and availability; and accepts from individual charterers cargo descriptions which include the loading and discharge locations of the route of a desired shipment of said particular cargo, and a specification of the time at which said desired shipment should occur.

### CROSS REFERENCE TO RELATED APPLICATION

This application claims the benefit of the filing date of U.S. Provisional Application Ser. No. 60/181,451 filed on Feb. 10, 2000.

### FIELD OF THE INVENTION

This invention relates to networked electronic communication systems for exchanging information and transacting business via the Internet and more particularly, although in its broader aspects not exclusively, to methods and apparatus for providing a Web-based information exchange service for the shipping industry.

### BACKGROUND AND SUMMARY OF THE INVENTION

The shipping industry comprises a large number of participants who conduct business primarily through an inefficient combination of postal mailings, telephone messages, facsimile transmissions and, to an increasing extent, email messages. For example, the marine transportation of petroleum involves the worldwide movement of crude oil and petroleum products on a host of tankers, operating primarily under international flag, which are owned by many different foreign and domestic ship owners. Domestic shipping is typically handled by coastal barges owned by competing barging companies. Most vessels are committed on a voyage-by-voyage basis, which is referred to as spot chartering. Many concentrate on a specific market, such as the Caribbean or Latin American markets. A smaller number of vessels are committed to a single charter for a fixed period of time, typically one year or longer.

A high percentage of both term and spot market shipping is conducted through brokers who are normally paid a commission for each fixture by the vessel owners. The brokers provide both shippers and charterers with market information. Some brokers post such information on the World Wide Web as a convenience to their clients. Each shipment further requires the performance of ancillary services which are provided by inspection companies, customs and customs agents, ship agents, linehandlers, chandlers, tugboat and pilot services, bunker providers, and the like, each of which must be separately identified, examined and contracted with.

There is accordingly a clear need for improved mechanisms for matching the needs of charterers desiring to transport goods with the services available from carriers and other shipping service providers.

In a principal aspect, the present invention takes the form of an Internet-based shipping marketplace which participants can use to exchange information and make commitments relating to the transportation of goods. In its preferred embodiment, the invention is implemented by one or more Web database servers which serve as an information and transaction hub for connecting charterers, ship owners and other carriers, brokers and agents, and shipping service providers.

As contemplated by the invention, ship owners, carriers and shipping service providers post information describing available services to the exchange server by using a form-based Web browser interface, or by uploading descriptive data in a structured format to the server. As used herein, the terms “ship owners” and “vessel owners” should be understood to include ship operators who do not necessarily own the ships they operate. Charterers may then post their requirements to the server in a structured format, also using a form-based Web browser interface. The server compares the requirements posted by the charterer with the descriptions of available services posted by the service providers, thereby matching the needs of the charterer with relevant services.

The exchange server is preferably adapted to utilize the posted information in a variety of ways, depending on the services requested. The charterer may simply be provided with the information concerning available services for review. The exchange server accordingly provides search facilities that allow charterers to conveniently search for, identify and compare services of interest prior to making a commitment. Vendors are likewise given access to market information that allows them to identify and better meet the current needs of charterers. In addition, as summarized below, charterers and vendors may use the services of the exchange to secure mutual commitments regarding defined services.

In a first mode, the charterer may use select desired services from matching availability data provided by the server and establish communications with the vendor via the exchange server to exchange further information before a commitment is made.

In a second mode, the charterer's initial request defining a needed service may be treated as a “request for quote” and the matching availability information which is posted by vendors and identified by the exchange server may be treated as a binding offer by each vendor which the requesting charterer may then accept, thereby creating a binding commitment.

In a third mode contemplated by the invention, charter services may also be aggregated to create a commodity sub-market for specific services of that kind. By way of example, a sub-market might be created for shipping petroleum between the Persian Gulf and United States Gulf ports. Carriers (ship owners), using a Web browser interface, may then post binding competitive offers to sell commodity services in that defined class, and charterers may post offers to buy services in that class, thereby creating an open-market environment for that class of services which is managed by the exchange server. The server matches the offers and bids to conclude commitments between the parties, and generates market information which is generally accessible to registered vendors and charterers indicating the current market price at which commitments have been most recently made for the service commodity which is the subject of that sub-market. In addition, such market information may be made publicly on a Web site published by the exchange server, or through other channels, while preserving the confidentiality of data on specific transactions.

The exchange server makes available industry-standard contract forms and documentation which define the terms upon which commitments are made, and provides generates full documentation for each commitment which is then provided to the parties to that commitment. The transmission of information and any documentation which describes each transaction, as well as any transfer of funds, is preferably conducted using conventional secure transmission means, such as the industry standard Public Key Infrastructure (PKI) and Secure Socket Layer (SSL) protocols.

As further contemplated by the invention, ancillary services offered by the same or different vendors may also be presented to the charterer, either at the same time the prime commitment between the charterer and the carrier is made, or separately. In accordance with the invention, a Web-based interface is provided which permits ancillary service providers to post descriptions of available services to the exchange server. By way of example, marine shipping services may be described by structured data posted to the exchange server by inspection companies, bunker providers, tugboat and pilot services, connecting barging and land based carriers, customs and customs brokers, linehandlers, etc. Frequently, these services are offered at the point of origin (loadport) or destination (disport) for a particular route. As in the case of services offered by carriers, commitments for such ancillary services may be made in an open-market, competitive environment.

The present invention significantly lowers costs for both charterers and shipping service providers by providing both with the information needed to secure advantageous business relationships, by automating tasks now performed by conventional means, by simplifying transactions, reducing misunderstandings and providing accurate records through the use of standardized electronically-communicated documentation, and by promoting competition among vendors.

These and other objects, features and advantages of the present invention may be better understood by considering the following detailed description of the preferred embodiment of the invention. In the course of this description, frequent reference will be made to the attached drawing.

### BRIEF DESCRIPTION OF THE DRAWING

FIG. 1 is a block schematic diagram of a Web-based shipping exchange that implements the invention.

FIG. 2 is a data flow diagram illustrating the manner in which negotiations occur between ship owners and charterers.

### DETAILED DESCRIPTION

The shipping information exchange and transaction system contemplated by the invention preferably takes the form of a Web-based business-to-business communication, database and transaction system.

The methods and apparatus contemplated by the invention use conventional Internet World Wide Web instrumentalities. A Web database server 101 communicates with the Internet 100 via a secure interface and maintains a database 105 including:

1. Participant Registration Information (indexed by ID)

1. User names and passwords for secure access.

2. Contact information including mailing addresses, phone and fax numbers, email addresses.

3. Financial and banking relationships for funds transfers and to confirm credit status.

4. Corporate history and descriptive information.

2. Descriptions of offered services

1. Shipping services

1. Vendor ID

2. Route description or geographic zone(s) serviced

3. Dates available

4. Capacity (minimum and maximum)

5. Carrier type (bulk carrier, dry goods carrier, container ships, petroleum, etc.)

6. Cost

2. Ancillary services

1. Vendor ID

2. Location available

3. Dates available

4. Capacity (minimum or maximum, if any)

5. Service type (e.g. inspection services, customs broker, linehandler, pilot, tug service, etc.)

6.

3. Description of services desired by charterers or other vendors

1. Charterer or Vendor ID

2. Route or location description (load and discharge location)

3. Date(s) needed

4. Capacity required

5. Carrier or Service type desired

6. Offered fee amount (or limit)

The foregoing information is preferably stored in a Web-enabled relational database system of conventional design, such as the Oracle 8i Web Database system offered by Oracle Corporation of Redwood Shores, Calif., or the equivalent. Such database systems typically operate in the environment provide by an operating system host such as Unix, Linux or Windows NT, on conventional computer hardware provided with a high speed Internet connection. Web database systems of this kind typically include support for an HTML forms-based interface with client browsers using the HTTP protocol. Data is exchanged between the database 105 and client computers via the Internet by performing SQL search, retrieval and update operations which, on the client side, are presented in HTML Web pages and forms which may be completed and submitted to the exchange server and which may include Java applets for performing selected functions on the client side.

Participants who use the services provided by the exchange server may use conventional form-based registration procedures to post participant data to the database. Thereafter, the exchange server employs user account information and password protection to control access to services and data provided by the server, limiting access to authorized personnel only. This access control prevents unauthorized persons from uploading or accessing data or obtaining services that are intended for use only by authorized registrants. Moreover, data is preferably partitioned so that only authorized participants may get access to their own account data, or to data describing transactions to which they are a party. Still further, access privileges vary for different data so that, for example, data describing completed commitments may be modified only by authorized system supervisors, but may be viewed by the authorized charterer or vendor who is a party to the transaction.

These services and data may be accessed by transmitting conventional HTML web pages using HTTP to client computers from the exchange server 101 via the Internet 100. The connected client computers, to be described, execute conventional web browser programs, such as Netscape Navigator or Microsoft's Internet Explorer, to view Web pages, and to complete and submit HTML forms to the exchange server 101. Data in the form of structured data files (advantageously expressed in the Extended Markup Language “XML”), as well as image, video, audio and text files may be uploaded to the exchange server by the a participant by requesting an upload services made available by web pages from the server, typically by entering the name of the data file to be uploaded, and then using conventional FTP file transfers to upload the identified data files to the server for storage and further processing. Participants may employ conventional text, image, video and audio composition and editing tools to create or update files, which may then be uploaded to the server.

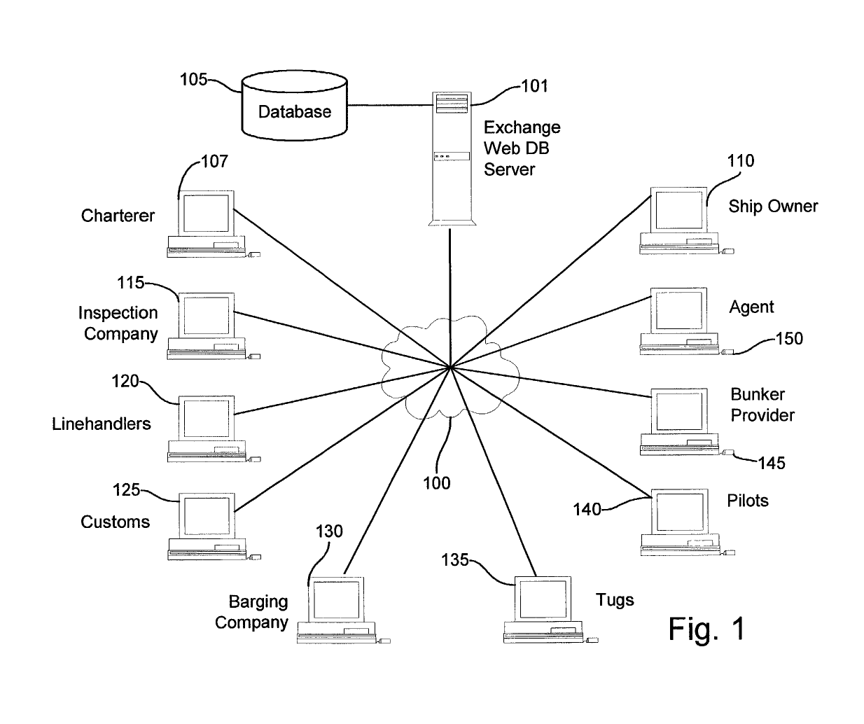

The exchange server 101 sends information to and receives information from multiple participants that are illustrated in FIG. 1 by a charterer 107, a ship owner 110, an inspection company 115, a linehandler 120, a customs agent 125, a barging company 130, a tugboat operator 135, a pilot 140, a bunker provider 145, and an agent 150. After all of these participants has registered and posted information describing their organization, the vendors further complete HTML forms issued by the server 101, or upload previously created data files, including XML data derived from a vendor database, to provide searchable structured data defining those shipping services which are offered. The pre-registered charterer 107 then logs into the exchange and submits a request for services by completing an HTML form which accepts structured data defining the desired shipping service. The exchange server then performs an SQL retrieval from the relational database 105 which matches the attributes of the available services with the attributes of the desired shipment. The availability data on the matching services returned by the database 105 are then converted into an HTML Web page form listing which is returned to the charterer 107 for inspection and further action.

At that time, depending upon the mode of operation being employed, the charterer 107 may do nothing, may communicate directly with a particular vendor, such as the ship owner 110, to secure more information, may treat the listed information as a binding offer for services which may be accepted to create a commitment, or may be informed that a commodity sub-market has been created for the requested services and be advised of the current market price and terms available in that sub-market for immediate purchase.

When a commitment is made for services, the server supplies a copy of standardized documentation for each party's records and, if appropriate data is in place to do so, automatically transfers funds as specified by the commitment using previously supplied financial data (bank and account numbers, credit card information, authorizations, etc.) previously stored in the secure database 105. The documentation, which may take the form of industry standard Portable Document Format (PDF's Adobe Acrobat®) files and/or XML data, may be transferred to those participants who are parties to the transaction and further saved in the database 105 for future reference by those parties. In accordance with an important feature of the invention, the exchange server preferably provides and retains a complete electronic “paper trail” which fully and automatically documents all transactions.

After, prior to, or concurrently with the transaction that creates a commitment between the charterer and a particular carrier (e.g., between charterer 105 and ship owner 110), the charterer and the vendor may also be advised of the availability of ancillary services which will be needed to consummate the shipment. For example, the exchange server may respond to a request from the charterer by returning one or more Web pages which list, in addition to the services of available carriers, the services of inspection companies and linehandlers at both the loadport and disport, and the services of customs brokers at the disport in case of international shipments. Similarly, the carrier may be advised of services it may require, including tugboat services, pilots, bunker providers and customs brokers. Note that, in the later case, the registered participant which acted as a vendor in one phase of arranging a shipment acts a purchaser of support services in another phase. In both cases, the exchange server 101 facilitates the negotiation which leads to desired commitments with these ancillary service providers, and provides full documentation and funds transfer services to the participants.

In some cases, a party to an existing past commitment may be unwilling or unable to fulfill that commitment and may wish to offer its contractual right to buy or to sell to another who will actually perform or use that service. To facilitate this, the exchange server 101 may advantageously maintain an auction facility under which holders of contract rights secured using the exchange may place those previously bargained-for rights on the market again for purchase by others. Thus, for example, a charterer may offer its right to ship petroleum from the Persian Gulf to a U.S. Gulf port to another charterer by submitting those rights to the auction facility. Similarly, a carrier may offer its contract right to payment for transporting a given shipment to another carrier using the auction. To facilitate this possibility, the transferability of commitments made using the server is preferably a standard, although optional, term of each commitment. In should be noted that, in the open-market environment created for services which fit into predefined commodity categories, contracts rights previously secured in that open market may be readily resold in the same market. As with any open market, the open market in such shipping commodities allows participants to execute hedging and investment strategies that tend to provide beneficial stability to the market and security to the participants.

Web Site Implementation

The structure and operation of an Internet Web site that implements significant features of the invention is described below. This Web site provides end-to-end logistics management solutions for the oil industry, uniting key partners in the value chain and facilitating transactions among buyers and sellers, cutting costs, and creating new business opportunities for the participants. The Web site makes the core ship chartering process available online while simultaneously integrating the service offerings of key constituencies that fulfill the requirements of a ship, both pre- and post-fixture. The Web site provides services to ship charterers and owners, as well as inspection companies, ship agents, barging companies and terminalling facilities. The services provided to participants by the Web site reduce costs, improve decision-making, and expand revenues by expanding the customer base. The Web site enables traditional charterers and owners to perform transactions online in an efficient and effective manner and provides access to the latest and most accurate industry information, thereby permitting users to make the best decisions and gather all their informational needs.

The principal functions performed by the Web site as described in more detail below are:

Online Ship and Barge Chartering
Broker Portal
Fixture Reports
Position Lists
Specific Trading Information
Sub-portals—External Content
Weather
Industry News
General News
Terminal Leasing Services
Agent Interface
Inspection Services Interface
Industry Tools
Supporting Services

Online Ship and Barge Chartering

Introduction

The process of fixing a ship online is a central function of the Web site. The process links buyers (charterers) and sellers (ship owners) and streamlines their shared process of chartering a ship. Additional functionality, including linking other members of the value chain (suppliers, vendors, and other service providers) is discussed later.

The two primary constituents involved in the process of fixing a ship are the ship charterer (i.e. the buyer of the service) and the ship owner (i.e. the seller of the service). The other constituents (agents, inspection service providers, product suppliers, and terminal operators) are involved in the process but removed from the chartering process, and their role is described separately later.

Registration

The process of registering chartering principals (owners and charterers) gathers descriptive data about these participants (member companies) and then assigns rights to member companies which enable them to add users and levels. A potential user of the system can go to the Web site homepage, and obtain, fill out and obtain an online application. After verification by the Web site, the new user will then be assigned a user login/password.

User profile information submitted by users during the registration process is stored in a database accessible to the Web site server. Profiles for owners include static vessel information (updated periodically) and preferred business partners, including charterers, brokers, and agents. Profiles for charterers include preferred business partners, including owners, inspection companies, and terminalling companies. Other user specific preferences include terms and conditions, measurement (metric/US), and news feeds.

Entering Open Requirements and Positions

In order to conduct chartering of vessels online, there are two major groupings of information (open requirements and open positions) that are submitted into the system and updated when appropriate. The cargo requirements as posted and updated are them matched against the posted and updated vessel information (open positions) to identify a matching ship and cargo requirement To facilitate the entry of required and desired information, the charterer is presented with one or more validating forms which are used to submit the following information describing each new cargo:

| Field Label | Input Type | Required? |
|---|---|---|
| Indication | Radio button | Yes |
| Firm | Radio button | Yes |
| Load Area | Drop down | |
| Discharge Area | Drop down | |
| Load port | Edit box | Yes |
| Discharge port | Edit box | |
| Reference point | Edit box | |
| Restrictions | Edit box | |
| Cargo type | Radio button | |
| Cargo name | Drop down | |
| Cargo quantity | Edit box | |
| Laycan start | Calendar | |
| Lancan End | Calendar | |
| Special requirements | Edit box | |
| Confidential? | Radio button | |
| Purge After | Edit box | |
| Search for match | Button | |

The shipowner is presented with one or more validating forms which are used to submit the following information describing each available vessel:

| Field Label | Input Type | Required? |
|---|---|---|
| Owner | Drop down | Yes |
| Vessel name | Drop down | Yes |
| Port open | Drop down | Yes |
| DWT | Edit box (auto populate) | Yes |
| Year built | Edit Box (auto populate) | Yes |
| Cubic capacity | Edit box (auto populate) | Yes |
| Cargo type (clean, dirty, both) | Radio button | Yes |
| Last or Next Discharge Port: | | |
| Area | Drop down | Yes |
| Port | Drop down | No |
| ETS LDP | Calendar | Yes |
| Comments | Edit box | No |
| Date Position Open Until | Calendar | No |
| Add to list and match | Check box | Yes |
| Submit | Button | Yes |

To simplify the entry of open position information, the user may identify the vessel owner on whose behalf the entry is to be made. Then, the user will be presented with a drop down listing of all vessels associated with that owner. The user may then chose a vessel from this listing, or e for a listing of all vessels in the system. When a vessel name is entered, the data from the last open position entry made for that vessel will then be used to populate the Last or Next Discharge port fields. The user may then update the Last or Next Discharge fields with the new information. The prior Last Position and all associated Projected Positions will be cleared from the system and replaced by the new Open Position and associated Projected Positions.

Matching Engine (Chartering)

After a user enters and submits a cargo requirement or open vessel position, the search engine will find and display a “Results” page listing of all possible vessel matches for the cargo input.

The ship match is based on the following criteria:

1. Cargo size/Ship size

2. Cargo type/Ship's last cargo (compatibility)

3. Cargo load dates/Laycan

4. Load port/Position of ship (from reference point)

The “Results” page produced by the matching process preferably consists of a tabular listing containing the following information: RFO number, Ship name, Approvals, DWT, Cubic Capacity, Last Discharge Port, ETS Last Discharge Port, Last 3 cargoes, and Available until.

On the Results page, alongside each of the listed vessels, a check box may be displayed to identify the vessel(s) for which the charterer wishes to make an offer, or to identify the public cargo the vessel owner would like to make an offer to carry. Additional details for a specific vessel can be found by clicking onto the vessel name on the Results page, and the resulting display contains detailed ship information previously submitted by the shipowner. From the expanded ship details, the charterer will drill down onto the desired vessel and review the information.

If the charterer wishes to submit an offer for this vessel, he will press the “Submit Offer for this Vessel” button displayed on the vessel detail page.

Communication/Negotiation Engine (Chartering)

The Web site supports electronic communication (bid/counterbid) between owner and charterer. Once there is an agreement between the parties, the ship is placed on pending status, subject to the satisfaction of several conditions, which can be initiated by either party. This is the equivalent of the vessel being put on hold by the charterer so the ship owner can no longer negotiate another rate with other charterers. While the charterer can retract an offer with ease, the participating ship owner usually does not have that type of freedom.

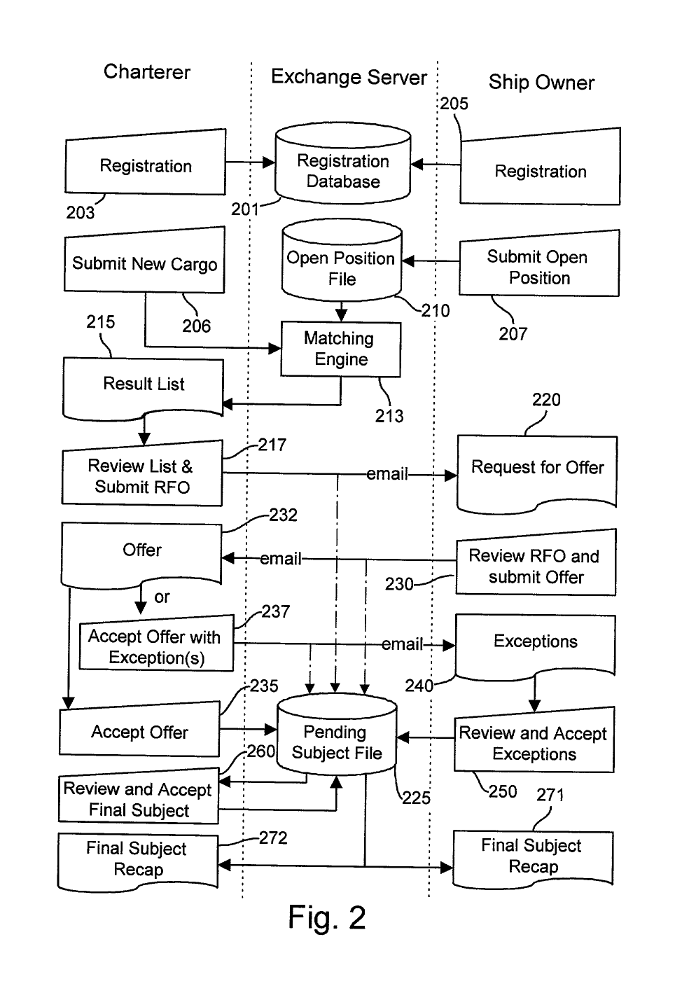

As depicted in the flow chart seen in FIG. 2, before the chartering negotiation begins, the charterer and the ship owner have both supplied information to the registration database 201 during the registration process as indicated at 203 and 205. The vessel owners submit descriptions of available vessel capacity as indicated at 206, which are added to the open position file seen at 210. When a new cargo description submitted by a charterer at 206 is compared by the matching engine 213 with the content of the open position file 210 to produce the result listing 215. The negotiation process begins when the charterer reviews the result list and issues an RFO (Request For Offer) as seen at 217.

The RFO is automatically constructed by the exchange server based on the information in the new cargo description submitted at 212, the description of the matching open position posted at 207, and selected information describing the charterer and the vessel owner obtained from the registration database 201. The vessel owner is sent this information by email as seen at 220 and a new pending subject is created in the pending subject file 225.

As seen at 230, the vessel owner reviews the RFO and submits an offer which is posted in the pending subjects file 225 and sent by email to the charterer as seen at 232.

The charterer reviews the offer received at 232 and then either ignores the offer (which terminates the negotiation), accepts the offer as made as indicated at 235, or accepts the offer subject to stated exceptions as indicated at 237.

If the charterer accepts the offer subject to exceptions, these exception conditions are communicated to the vessel owner as seen at 240 and are posted to the pending subject file.

If the original offer is accepted by the charterer at 235, or is accepted subject to conditions which are then accepted by the vessel owner as seen at 250, the pending subject as accepted is communicated to the charterer for final acceptance as seen at 260. Once the charterer submits the final acceptance, the final subject is described in a recap message sent by email to both the vessel owner and the charterer as seen at 271 and 272.

In addition to the foregoing exchange of information, the Web site also produces and distributes documentation designated as “Supplier Nomination of Vessel” and “Voyage Orders.” The Supplier Nomination and the Voyage Orders are initiated by the charterer or the operational department of the chartering organization and are sent to the supplier (e.g. the supplier of the petroleum, usually at the loadport) and to the ship owner.

Wireless Messaging

Because many users of the system travel frequently, it is important to provide mechanisms that will help insure that time-critical messages and notifications are delivered even when the intended recipient is away.

To support wireless messaging, when a new user first registers, they are asked to provide not only an email address and a conventional telephone number, but also a cell phone number, pager number, or access information that will permit a transmission to be made to another kind of WAP enabled device, such as a PDA. By identifying alternative contact information, messages and notifications can be communicated even when the user is not logged into the system or reachable at the user's normal primary email address or telephone number.

Even brief notification messages communicated via a pager or PDA can be used to advise a user that detailed information has been posted that deserves the user's attention and is available via the system Web site. The user who has received an email, pager or PDA notification will then have the option to log on to the system's “wireless site”, a customized front end version of our site for wireless devices which interacts the same way with the system's backend processes and database, but which presents and accepts information in a format (such as WML (Wireless Markup Language) which is compatible with the wireless device used to contact the wireless site. In this way, a user can continue a negotiation, contact inspection agencies, send message to another relevant user's cell phone, or even fix a ship over his wireless device.

By sending even a brief message which is compatible with the user's handheld wireless devices, key information can be made available when needed. For example, if a shipowner is playing golf on the golf course in London and the time a charterer issues an RFO reflecting a need for available capcity, the following message may be transmitted for display on the shipowner's cell phone:

| Message from: | Charterer |
|---|---|
| Name: | Joe |
| Company: | Repsol |
| Cargo: | Crude oil |
| Laycan start date: | 02/09/2001 |
| Laycan end date: | 02/22/2001 |
| Discharge Area: | Port of Spain |
| Grade: | 1 |

Click here for details

The shipowner can then use his cell phone to log onto the wireless site, access relevant information, and continue and close the negotiation. Similarly, a charterer who completes a negotiation on a wireless device can contact Inspectors and agents. Moreover, the wireless site will permit an inspector to do inventory management or enter details of a ship while he is inspecting it, using a PDA to exchange information with the system while the inspector is on-site.

Broker Portal

The Web site further provides information that ship chartering principals use to proceed with the chartering transaction. This information is preferably updated at least twice daily and serves as the informational baseline for principals use in transactions. The Web site organizes and presents relevant market information for each of the major trading regions in the world. This market information preferably include information regarding:

Ship fixtures

What ships were fixed and at what price

What ships pending, and not fixed

Position lists

Ship name, last discharge port, ets last discharge

Specific trading information—Analysis of regional markets and other information

Special market reports—Tanker news

Search facilities permit this information to be retrieved by region, vessel, and type of cargo

Sub-portals (3^{rd} Party Informational Services)

The Web site further implements interfaces to external sites that provide useful information and functionality to the ShipIQ.com user A sub-portal may be implemented as a click-through within a frame or as a separate browser window. In order to provide users to access to password protected sites, a Single Server Sign On procedure may be used to facilitate access to information from protected partner sites. In this way, when connecting to other sites, users will not need to log on a second time and may access data from external sites in a transparent process. External data which may be usefully made available includes:

Weather

Industry News (OPEC, environmental issues, tanker update)

General News

Agent Interface

The Web site preferably provides ship owners with the ability to access agent information from ports and nominate agents via email. Owners may nominate agents at the end of the chartering transaction by clicking on a form button to obtain a listing of all known agents at that load port. Upon choosing an agent, an email may then be automatically sent to that agent containing the required information regarding the completed transaction. The initial upload of the agent information will be performed by the Web site's editorial staff using the Web site's agent interface and updated whenever changes are made to the information.

Inspection Service Interface

In a similar manner, the Web site further provides the ability to nominate inspection companies to perform specified services. Upon completion of a chartering transaction, charterers can nominate inspection companies by pressing a button that retrieves up an inspection nomination form. This form is populated with data from the completed transaction completed and can be sent via email to the nominated company. After nominating an inspection company, the user will receive a notification that inspection nomination has been received and that service will be provided. Inspection companies conduct Quantity and Quality (Q and Q) inspection services and post inspection reports onto Web site database for access by customer. These inspection reports will be accessible to users of the Web site through secured access to database.

Terminal Leasing Interface

The Web site may also advantageously provide a terminal leasing interface that allows users to access tank availability status by terminalling company, geographic area, or terminal. Users will thus be able to locate available tank storage and associated information and contact and negotiate with terminalling companies. Automatic email facilities are provided to enable users to conveniently send email the terminalling company with requests for information.

Industry Tools

The Web site preferably provides access to a number of tools that will help the site user conduct valuable tasks. These services assist charterers and chartering managers in their daily tasks. These tools include:

A “Voyage Calculator” which produces distance tables and a profitability calculator

Currency Conversion Calculators (coupled to an external source of currency exchange rate data)

Demurrage Calculator (integrated from 3^{rd} party source)

Loss Control Monitoring (integrated from 3^{rd} party source)

Supporting or Infrastructure Services

Security. The integrity and security of data, both as stored in the Web site's database and as exchanged with users during transactions and other phases of the system's operation, should be assured through the use of available secure data storage and transmission mechanisms, and access to the data should be protected by a carefully administered system of user enrollment and update, password integrity and transaction reporting procedures.

Customer Service. The Web site should be further supported by other conventional methods including FAQ (Frequently Asked Questions) pages, demonstration pages, customer service telephone support, and email help desk support.

Conclusion

It is to be understood that the foregoing description is merely illustrative of one application of the principles of the invention. Numerous modifications may be made to the system described without departing from the true spirit and scope of the invention.

What is claimed is:

1. The method of providing an Internet-based shipping marketplace which permits charterers and ship owners to exchange information and make commitments relating to the transportation of goods, said method comprising, in combination, the steps of:
connecting one or more Web database servers to the Internet,
programming said one or more servers to act as a communication hub for exchanging information with charterers and ship owners and for establishing communications links between said charterers and ship owners,
employing said communications hub to accept and store from individual ones of said ship owners vessel description information that identifies individual vessels and their describes their current location and availability,
employing said communications hub to accept from individual ones of said charterers cargo descriptions which specify a particular cargo, the loading and discharge locations of the route of a desired shipment of said particular cargo, and a specification of the time at which said desired shipment should occur,
matching a received one of said cargo descriptions with the vessel description information stored by said communications hub to produce a result listing identifying vessels which are potentially available to handle the cargo specified by said received cargo description,
transmitting said result listing to the particular charterer that submitted said received cargo description,
accepting from said particular charterer the designation of a particular vessel specified on said result listing as being potentially available to handle said desired shipment,
employing said communications hub to transmit to the owner of said particular vessel a request for an offer, said request for an offer containing information extracted from said received cargo description,
employing said communications hub for accepting from said owner of said particular vessel an offer to handle said desired shipment and for transmitting said offer to said particular charterer,
accepting from said particular charterer an acceptance of said offer, and communicating to said particular charterer and to said owner of said particular vessel a description of the shipping commitment represented by said accepted offer and acceptance.

2. The method set forth in claim 1 further including the steps of employing said communications hub to store information describing a plurality of service providers that may be employed in connection with a shipment, employing said communications hub to accept a search request specifying one or more desired attributes of service providers of interest to a requestor, employing said communications hub to return to said requestor a listing of those service providers having attributes which match said desired attributes.

3. The method set forth in claim 2 wherein said information describing said service providers includes the email address of each of said service providers, and further including the step of automatically transmitting an information inquiry email on behalf of said requestor to one or more of the service providers identified on said listing.

4. The method set forth in claim 3 wherein said service providers include shipping agents.

5. The method set forth in claim 4 wherein said service providers include providers of inspection services.
